(19) United States
(12) Patent Application Publication
(10) Pub. No.: US 2008/0220221 A1
(43) Pub. Date: Sep. 11, 2008

(54) Cookware and Dinnerware Scratch Prevention Liner

(76) Inventor: Cheryl L. Koski, Pompano Beach, FL (US)

Correspondence Address: ROBERT M. SCHWARTZ, P.A., P.O. BOX 221470, HOLLYWOOD, FL, 33022, US

(21) Appl. No.: 12/043,188

(22) Filed: Mar. 6, 2008

Related U.S. Application Data
(60) Provisional application No. 60/893,409, filed on Mar. 7, 2007.

(51) Int. Cl. B32B 23/02

(52) U.S. Cl. 428/193

(57) ABSTRACT

The present invention is an article for protecting the surface of non-stick cookware comprising a flexible main body and a flexible border about the perimeter of said main body to protect the lower surface and side walls of cookware.

### INDEX TO RELATED APPLICATIONS

This application claims the benefit of U.S. Provisional Patent Application Ser. No. 60/893,409, filed Mar. 7, 2007 the disclosure of which is incorporated herein by reference in its entirety.

### SUMMARY OF THE INVENTION

In order to save kitchen cabinet space, many people stack their pans or skillets one on top of the other. Over time, this stacking of pans can cause abrasions and scratch marks on the pan's nonstick or stainless steel cooking surface. When scratches and abrasions appear on the cooking surface of a nonstick pan, the nonstick coating may begin to flake off, and food then has a tendency to stick in those areas of the pan. This flaking off of the nonstick material can adhere to prepared food during the cooking process and then be unintentionally consumed. When purchasing costly stainless steel pans, one would prefer to keep them in the best shape possible and avoid a scratched cooking surface.

Some people like to use different types of pans for different purposes. Some prefer stainless steel pans for browning meats, while nonstick pans are preferred for cooking eggs, crepes and omelets. It is common for people to purchase more than one frying pan or skillet in various sizes. Probably the most common sizes would be the 8″, 10″ and 12″ pans, and 9″ and 11″ pans.

The present invention is a scratch prevention liner to be used between frying pans or skillets that are stacked one on top of the other during storage.

The scratch prevention liner of the present invention is generally circular with an edging sewn around the circular liner producing upwardly extending sides (when the side edging is turned up). The side edging can also lay flat to serve other purposes which will be explained in a later paragraph. The main inner circular section of the liner is made of soft fabric.

Quilted type of fabric provides a good cushioning effect, although other fabrics may also be suitable. There may be two circular-cut cushioned fabric pieces placed together with right sides facing out so that the scratch prevention liner is reversible.

Alternatively, a single circular-cut fabric piece may be used. The fabric is double faced quilted so only one circle needs to be cut and the fabric is reversible with cushioned material in between.

A fabric edging approximately 2″ wide can be sewn around the circular-cut cushioned fabric. This attaches all pieces together. The edging can be of a ruffled edging, or other edging may also be suitable. The edging folds up forming a wall so that when inserted between pans the upwardly extending edging protects the inner side walls of the bottom pan, with the circular-cut cushioned fabric being the middle section of the liner protects the cooking surface of the bottom pan, when storing pans stacked one upon the other.

The circular-cut cushioned fabric can be made available in different color options, can be a solid color, checked, or patterned fabric. Various color options can be made available for the edging trim as well. As an option, a decorative piece or monogram can be placed or sewn in the middle of the circular-cut cushioned fabric.

Another aspect of this invention is that the scratch prevention liner can also lie flat, without folding the edging sides up, and can then lie flat and be placed between fine china plates, glass serving trays, ceramic, porcelain, or any items you wish to protect that have a tendency of being scratched when other items are stacked upon it.

The scratch prevention liner creates a cushioned buffer between stored items to prevent abrasion and scratches when other items are stacked on top of it. It also helps to keep dust from collecting on the cookware or dinnerware. It is easily placed between items. It is reversible, and can be machine washed and dried. When storing nonstick pans stacked one on top of the other, the scratch prevention liner is an easy solution to prevent scratches and flaking off of the nonstick coating that can adhere to food during the cooking process and be unintentionally consumed. The scratch prevention liner will keep expensive stainless steel pans and other types of pans from abrasion and scratch marks that can happen when the pans are stored in a stacked fashion. The scratch prevention liner can also lie flat when the side edging is not turned up, and can then lie flat and be used between fine china plates, glass serving trays, or any items you wish to protect from scratches and abrasions that can occur when other items are stacked upon it.

In one embodiment, the present invention is an article for protecting the surface of non-stick cookware comprising:

(a) a flexible main body; and
(b) a flexible border about the perimeter of said main body;
wherein said border has flexation that allows said liner to extend upward along the inner wall surface.

The main body may be formed of fabric cloth or any other suitable material. Preferably, the flexible main body has attached upper and lower cloth portions and a soft material placed therebetween to provide a cushioning effect.

In one embodiment, the fabric cloth may be quilted.

The article also has a flexible border is formed of fabric cloth or other suitable material. The flexible border is configured to extend upward along the inner wall surface and permit nesting type storage of a plurality of cookware.

Also contemplated is a method for protecting the inner lining of cookware comprising the steps of:

(a) placing an article having a flexible main body and a flexible border on the inner surface of a cookware vessel;
(b) orienting said article such that said main body is aligned with the bottom of the cookware and, in embodiments with a flexible border, the flexible border extends upward along the interior wall of said cookware;
(c) placing another cookware vessel on the surface of said article;
(d) repeating placement of said article for each cookware vessel in need of protection.

### BRIEF DESCRIPTION OF THE DRAWINGS

FIG. 1 is a top view of the article.

FIG. 2 is a side cross-section view along lines A-A from FIG. 1.

FIG. 3 is a top view of the article.

FIG. 4 is a side cross-section view along lines B-B from FIG. 3.

FIG. 5 is a side cross section view of the article placed between two nesting pans.

FIG. 6 is a top view of the article.

FIG. 7 is a side cross section view along lines C-C from FIG. 6.

FIG. 8 is a side cross-section view showing three articles on the bottom of three nesting pans.

FIG. 9 is a top view of the article.

FIG. 10 is a side cross-section view along lines D-D from FIG. 9.

### DETAILED DESCRIPTION OF THE PREFERRED EMBODIMENT

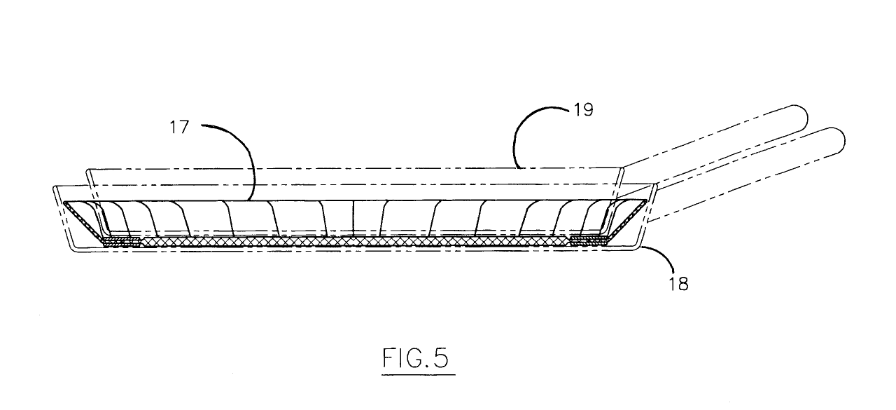

As shown in FIG. 1, article 10 has a main or central padded body portion 16. Main portion 16 is circumferraly surrounded by a first upper flexible border portion or ring 25 that is connected to main body 16 at interface 15 and secured into position with stitching 35. A second flexible border portion or ring 12 is connected to the first border portion 25 at first border portion interface 13 and secured into position with stitching 34. Either of the first flexible border portion 25 or second flexible border portion 12 may additionally have decorative edge 17 attached to the outer circumferral surface thereof. Article 10 separates pan 18 and pan 19 when said pans are in a nesting position as shown in FIG. 5.

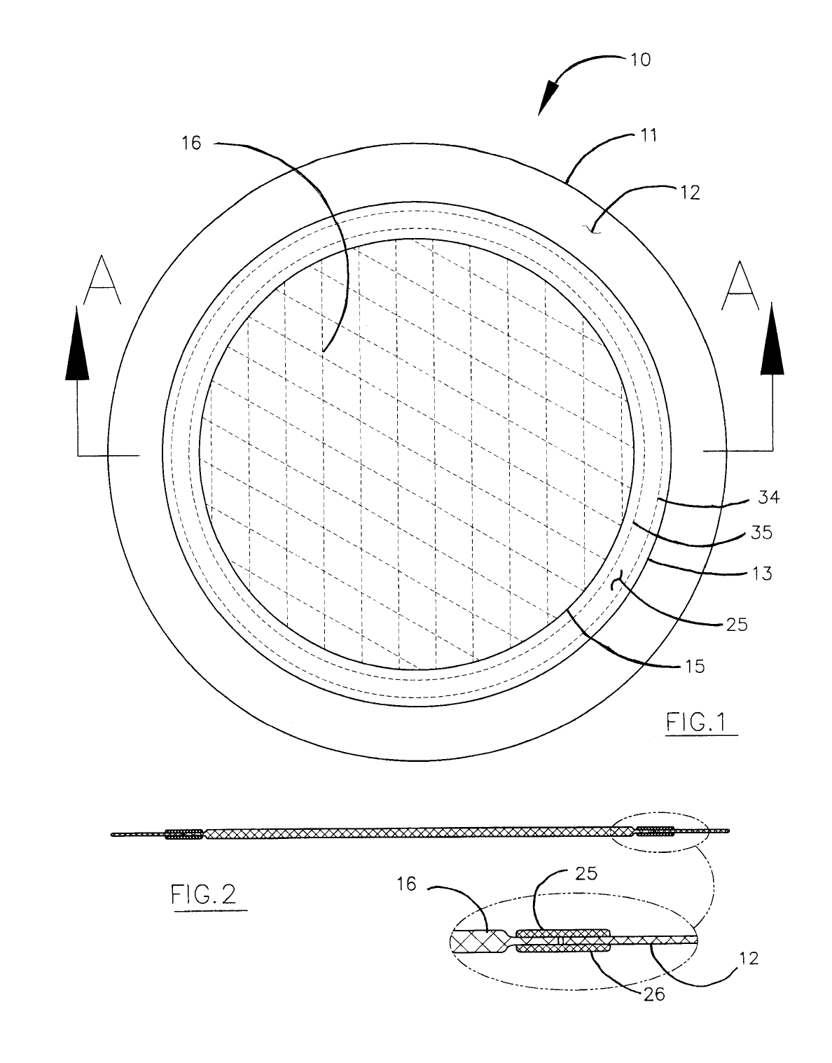

As shown in FIG. 2, in cross section, main body 16 is held between upper flexible body portion 25 and lower flexible body portion 26 that are secured in place by stitching 34 and 35.

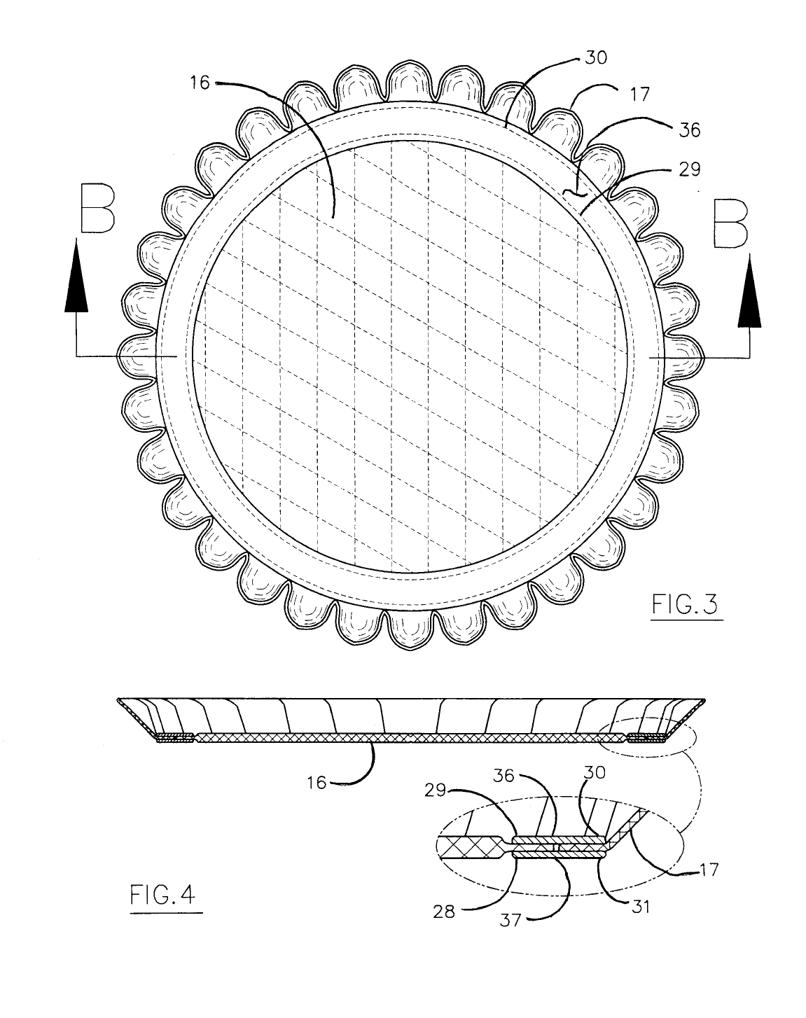

The embodiment of FIGS. 3 and 4 show decorative upper flexible body portion or ring 36 and lower flexible body portion or ring 37 secured to main body 16 with stitching 28 and 29. Portion 36 has decorative outer ring 17 secured to body portion 36 with stitching 30 and 31.

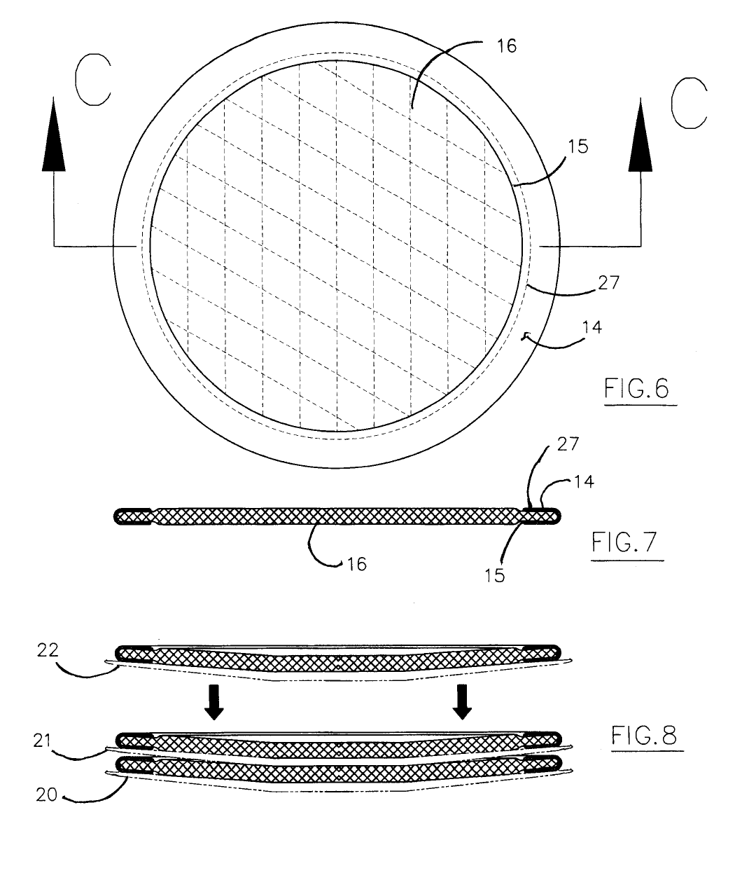

FIG. 6 demonstrates another embodiment having article 10 with a main or central padded body portion 16. Main portion 16 is circumferraly surrounded by a flexible border portion or ring 14 that is connected to main body 16 at interface 15 and secured into position with stitching 27. Flexible border portion or ring 14 wraps around the edge of main body portion 16. Article 10 may be positioned between stacked pans to protect flat cooking surface of pans and does not have upwardly extending sides. Additionally, as shown in FIG. 8, article 10 may be positioned between conventional dinnerware plates 20, 21 and 22; or can be used to protect other items that can be damaged when storing items in a stacked or nested fashion.

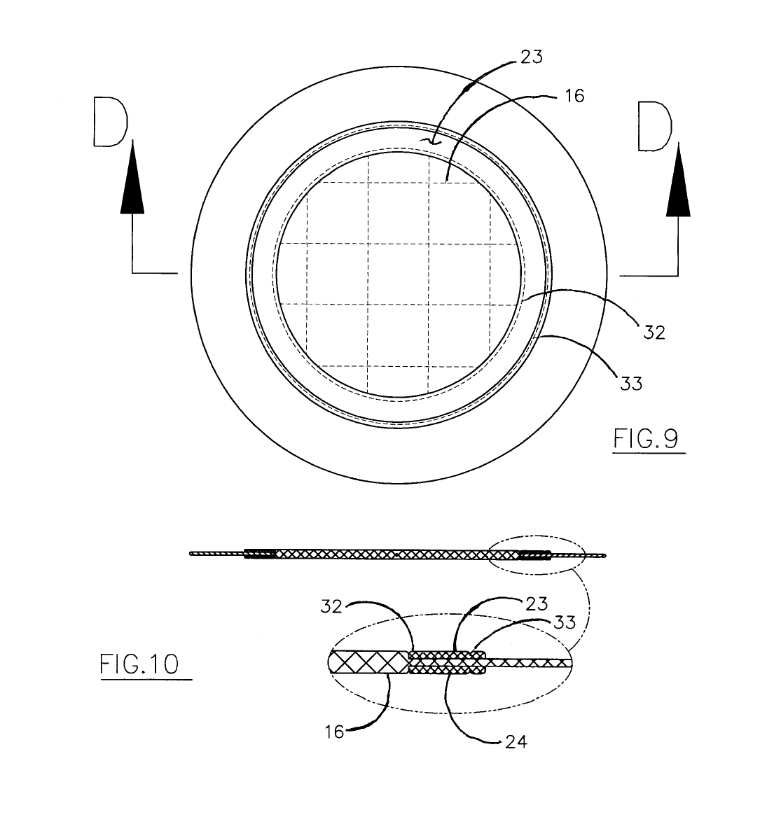

The embodiment of FIGS. 9 and 10 show main body 16 circumferraly bordered by upper border 23 and lower border 24 secured into position by stitching 32 and 33.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An article for protecting the surface of cookware comprising:
(a) a flexible main body; and
(b) a flexible border about the perimeter of said main body;
wherein said border has flexation that allows said liner to extend upward along the inner wall surface.

2. The article of claim 1 wherein said flexible main body is formed of fabric cloth.

3. The article of claim 1 wherein said flexible main body comprises attached upper and lower cloth portions.

4. The article of claim 1 wherein said upper and lower cloth portions have a soft material placed therebetween to provide a cushioning effect.

5. The article of claim 2 wherein said fabric cloth is quilted.

6. The article of claim 1 wherein said flexible border is formed of fabric cloth.

7. The article of claim 1 wherein said flexible border is configured to extend upward along the inner wall surface and permit nesting type storage of a plurality of cookware.

8. A method for protecting the inner lining of cookware comprising the steps of:
(a) placing an article having a flexible main body and a flexible border on the inner surface of a cookware vessel;
(b) orienting said article such that said main body is aligned with the bottom of the cookware and the flexible border extends upward along the interior wall of said cookware;
(c) placing another cookware vessel on the surface of said article;
(d) repeating placement of said article for each cookware vessel in need of protection.
